(19) United States
(12) Patent Application Publication
(10) Pub. No.: US 2020/0132839 A1
(43) Pub. Date: Apr. 30, 2020

(54) LIDAR DISTANCE MEASUREMENT WITH SCANNER AND FLASH LIGHT SOURCE

(71) Applicant: Blickfeld GmbH, Munich (DE)

(72) Inventor: Mathias Muller, Groebenzell (DE)

(21) Appl. No.: 16/619,552

(22) PCT Filed: Jun. 5, 2018
(86) PCT No.: PCT/DE2018/100537

§ 371 Date: Dec. 5, 2019

(30) Foreign Application Priority Data
Jun. 6, 2017 (DE) 10 2017 005 395.2

(51) Int. Cl. G01S 17/10; G01S 7/481; G01S 7/497

(52) U.S. Cl. CPC G01S 17/10; G01S 7/4811; G01S 2007/4975; G01S 7/497; G01S 7/4817

(57) ABSTRACT

A device comprises a first emission beam path, which extends from a pulsed first light source via a scanner to surroundings of the device. The device also comprises a reception beam path, which extends from the surroundings via the scanner to a detector. The device also comprises at least one second emission beam path, which extends from at least one pulsed second light source and not via the scanner to the surroundings.

### TECHNICAL FIELD

Various examples of the invention relate in general to the emission of light pulses, for example, for distance measurement by means of LIDAR measurement technologies. Various examples of the invention relate in particular to the emission of light pulses along different emission beam paths, which extend via a scanner and not via a scanner.

### BACKGROUND

The distance measurement of objects is desirable in various technological fields. For example, it can be desirable in conjunction with applications of autonomous driving to recognize objects in the surroundings of vehicles and in particular to ascertain a distance to the objects.

One technology for distance measurement of objects is the so-called LIDAR technology (light detection and ranging; sometimes also LADAR). In this case, for example, pulsed laser light is emitted by an emitter. The objects in the surroundings reflect the laser light. These reflections can subsequently be measured. A distance to the objects can be determined by determining the runtime of the laser light.

To recognize the objects in the surroundings in a position-resolved manner, it can be possible to scan the laser light. Different objects in the surroundings can thus be recognized depending on the emission angle of the laser light. A scanner can be provided for this purpose.

To make a corresponding device robust, it is typically necessary for the light source and the scanner to be arranged in one housing. The housing can comprise an outer pane transparent to the light.

Undesired reflections of the light can occur on the outer pane. This can be the case, on the one hand, because of a tilt of the emission beam path in relation to the outer pane. Such a tilt cannot be avoided or can only be avoided with difficulty in particular in conjunction with the two-dimensional scanning of light. A further reason for reflections can be soiling of the outer pane.

The scanner is sometimes also used for detecting back-reflected light. The reception beam path and the emission beam path can then extend at least partially congruently, and/or antiparallel and superimposed. Both the emission beam path and also the reception beam path extend via the scanner in this case. In such an implementation, a reflection back on the outer pane can cause saturation of the detector used, because a comparatively large amount of light is then incident. The detector is therefore “blinded” for the first nanoseconds after firing a pulse. This can mean that it can often be difficult to measure objects in the immediate surroundings for example, in the range of up to 10 m.

### BRIEF SUMMARY OF THE INVENTION

There is therefore a demand for improved technologies for LiDAR distance measurements. In particular, there is a demand for those technologies which alleviate or remedy at least some of the above-mentioned disadvantages.

This object is achieved by the features of the independent patent claims. The features of the dependent patent claims define embodiments.

In one example, a device comprises a first emission beam path. The first emission beam path extends from a pulsed first light source via a scanner to surroundings of the device. Moreover, the device also comprises a reception beam path, which extends from the surroundings via the scanner to a detector. The device also comprises at least one second emission beam path, which extends from at least one pulsed light source to the surroundings. The at least one second emission beam path does not extend via the scanner in this case.

In one example, a device comprises a pulsed first light source, which is configured to emit light via a scanner to surroundings of the device. The device also comprises a detector, which is configured to detect light via the scanner from the surroundings. The device also comprises at least one pulsed second light source, which is configured to emit light not via the scanner to the surroundings.

In one example, a method comprises the activation of a pulsed first light source to emit a first light pulse along a first emission beam path via a scanner into surroundings. The method also comprises the activation of a detector to detect a reflection of the first light pulse along a reception beam path, which extends from the surroundings via the scanner. The method furthermore comprises the activation of at least one pulsed second light source to emit a second light pulse along a second emission beam path and not via the scanner into the surroundings. The method furthermore comprises the activation of the detector to detect a reflection of the second light pulse along the reception beam path.

In one example, a device for LIDAR distance measurements comprises a first laser which is configured to emit laser pulses via a scanner. The device also comprises a FLASH laser, which is configured to emit laser pulses not via the scanner. A detector is configured to detect reflections via the scanner.

The above-described examples can also be combined with one another in further examples.

### BRIEF DESCRIPTION OF THE FIGURES

FIG. 1 schematically illustrates an exemplary device having a light source which emits via a scanner, a further light source which does not emit via the scanner, and a detector which receives via the scanner.

FIG. 2 schematically illustrates an angle range which is illuminated by the light source, a further angle range which is illuminated by the further light source, and a scanning range of the scanner of the device from FIG. 1.

FIG. 3 is a flow chart of an exemplary method.

FIG. 4 schematically illustrates the scanner according to various examples.

### DETAILED DESCRIPTION OF EMBODIMENTS

The above-described properties, features, and advantages of this invention and the manner in which they are achieved will become clearer and more comprehensible in conjunction with the following description of the exemplary embodiments, which are explained in greater detail in conjunction with the drawings.

The present invention is explained in greater detail hereafter on the basis of preferred embodiments with reference to the drawings. In the figures, identical reference signs identify identical or similar elements. The figures are schematic representations of various embodiments of the invention. Elements illustrated in the figures are not necessarily shown to scale. Rather, the various elements illustrated in the figures are reproduced in such a way that the function and general purpose thereof is comprehensible to a person skilled in the art. Connections and couplings between functional units and elements shown in the figures can also be implemented as an indirect connection or coupling. Functional units can be implemented as hardware, software, or a combination of hardware and software.

Various technologies for scanning light are described hereafter. The technologies described hereafter can enable, for example, the 2-D scanning of light. Scanning can refer to repeated emission of light pulses at different emission angles. A scanner can be used for the scanning. The scanning can comprise, for example, one deflection unit or multiple deflection units. The one or the multiple deflection units can be configured to deflect light—for example, pulsed laser light—once or multiple times. The deflection unit can comprise a mirror, for example. The deflection unit could also comprise a prism instead of the mirror. The scanner can comprise an elastic support element, which elastically suspends the deflection unit. Different positions of the deflection unit and thus different scanning angles can be implemented by reversible deformation of the elastic support element. It is possible that the elastic element is excited in a resonant or semi-resonant manner to effectuate the scanning (such technologies are sometimes also referred to as “resonant flexure scanning”). In various examples, at least one support element is thus used for scanning light, which has a shape-induced and/or material-induced elasticity. The at least one support element could therefore also be referred to as a spring element or elastic suspension. The support element comprises a movable end. At least one degree of freedom of the movement of the at least one support element can then be excited, for example, a torsion and/or a transverse deflection. In this case, different orders of transverse modes can be excited. By way of such an excitation of a movement, a deflection unit which is connected to the movable end of the at least one support element can be moved. The movable end of the at least one support element therefore defines an interface element to the corresponding deflection element. It would be possible, for example, that more than one single support element is used, for example, two or three or four support elements. These can optionally be arranged symmetrically in relation to one another.

The one or the multiple deflection units can be positioned at different scanning angles, different scanning angles can correspond to different emission angles of the light in this case. The sequence of scanning angles can be established by a superposition figure if, for example, two degrees of freedom of the movement are used in a chronologically—and optionally positionally—superimposed manner for the scanning. For example, the set of the scanning angles can define a scanning range. In various examples, the scanning of light can be performed by the chronological superposition and optionally a position superposition of two movements in accordance with different degrees of freedom of at least one elastic suspension. A 2-D scanning range is then obtained.

In various examples, a movable end of one fiber or multiple fibers is used as a support element for scanning the laser light: this means that the at least one support element can be formed by one or multiple fibers. Various fibers can be used as support elements. For example, optical fibers can be used, which are also referred to as glass fibers. However, it is not necessary in this case for the fibers to be produced from glass. The fibers can be produced, for example, from plastic, glass, or another material. For example, the fibers can be produced from quartz glass. The fibers can have a length, for example, which is in the range of 3 mm-10 mm, optionally in the range of 3.8 mm-7.5 mm. For example, the fibers can have a 70 GPa modulus of elasticity. This means that the fibers can be elastic. For example, the fibers can enable up to 4% material elongation. In some examples, the fibers comprise a core in which the supplied laser light propagates and is enclosed by total reflection at the edges (optical waveguide). However, the fibers do not have to comprise a core. In various examples, so-called single-mode fibers or multimode fibers can be used. The various fibers described herein can have, for example, a circular cross section. It would be possible, for example, that the various fibers described herein have a diameter which is not less than 50 μm, optionally not <150 μm, furthermore optionally not <500 μm, furthermore optionally not <1 mm. For example, the various fibers described herein can be designed as able to be bent or curved, i.e., flexible and/or elastic. The material of the fibers described herein can have a certain elasticity for this purpose. The fibers can comprise a core. The fibers can comprise a protective coating. In some examples, the protective coating can be at least partially removed, for example, at the ends of the fibers.

In other examples, it would also be possible that one or more elastic support elements are produced by means of MEMS technologies, i.e., by means of suitable lithography process steps, for example, by etching out of a wafer.

For example, the movable end of the support element could be moved in one or two dimensions—in the case of a chronological and positional superposition of two degrees of freedom of the movement. One or more actuators can be used for this purpose. It would be possible, for example, that the movable end is tilted in relation to a fixation of the at least one support element; this results in a curvature of the at least one support element. This can correspond to a first degree of freedom of the movement; this can be referred to as the transverse mode (or sometimes also as the wiggle mode). Alternatively or additionally, it would be possible that the movable end is pivoted along a longitudinal axis of the support element (torsion mode). This can correspond to a second degree of freedom of the movement. Laser light can be emitted at various angles by the movement of the movable end. For this purpose, a deflection unit can be provided, for example, a mirror optionally having suitable interface to the fixation. Surroundings can thus be scanned using the laser light. Depending on the strength of the movement of the movable end, scanning ranges of different sizes can be implemented.

In the various examples described herein, it is possible in each case to excite the torsion mode alternatively or additionally to the transverse mode, i.e., a chronological and positional superposition of the torsion mode and the transverse mode would be possible. This chronological and positional superposition can also be suppressed, however. In other examples, other degrees of freedom of the movement could also be implemented.

The superposition figure is sometimes also referred to as a Lissajous figure. The superposition figure can describe a sequence, using which the different scanning angles are implemented

In various examples, it is possible to scan laser light. In this case, for example, coherent or incoherent laser light can be used. It would be possible to use polarized or unpolarized laser light. For example, it would be possible that laser light is used in pulsed form. For example, short laser pulses having pulse widths in the range of femtoseconds or picoseconds or nanoseconds can be used. For example, a pulse duration can be in the range of 0.5-3 ns. The laser light can have a wavelength in the range of 700-1800 nm. For reasons of simplicity, reference is predominantly made hereafter to laser light; the various examples described herein can also be applied to the scanning of light from other light sources, for example, broadband light sources or RGB light sources. RGB light sources generally refer herein to light sources in the visible spectrum, wherein the color space is covered by superimposing multiple different colors—for example, red, green, blue or cyan, magenta, yellow, black.

Pulsed laser light can be used in particular. For example, pulses having a duration of approximately 0.5 ps-5 ns or optionally in the range of 1-2 ns could be used. The runtime of the pulses can then be used for the LIDAR distance measurement of an object in the surroundings (time-of-flight or TOF measurement).

In various examples, LIDAR technologies can thus be used for the distance measurement. The LIDAR technologies can be used to carry out a position-resolved distance measurement of objects in the surroundings. For example, the LIDAR technology can comprise TOF measurements of the laser light between the light source, the object in the surroundings, and a detector.

In various examples, an emission beam path from a light source to the surroundings and a reception beam path from the surroundings to a detector can extend at least partially congruently. This can mean in particular that both the emission beam path and also the reception beam path extend via the scanner, i.e., are deflected by one or multiple deflection units. A spatial filtering can thus be achieved. Only light is detected from the surrounding region which was previously also illuminated. A particularly high signal-to-noise ratio can thus be achieved. Moreover, a high degree of integration and small external dimensions can be achieved by the congruent emission and reception beam path.

Various examples are based on the finding that it can be difficult in such a scenario of the spatial filtering to measure the distance to particularly close objects. This can be because an emitted light pulse is reflected at least partially on the outer pane of the device; the light reflected in this manner saturates the detector—for example, a single photon avalanche diode array (SPAD) detector—for a certain saturation duration. Moreover, a reflection can take place on the deflection unit or units of the scanner. The saturation duration is typically in the range of several tens of nanoseconds and thus in the range of the light runtime for objects in the close surroundings in the range of up to, for example, 10 m. A separation of emission and reception beam path—cf., for example, DE 10 2010 047 984 A1—to avoid such a saturation can only be implementable with difficulty in particular in the case of two-dimensional scanning ranges and/or can require a significant enlargement of the scanner. Therefore, technologies are described hereafter in which it is possible in spite of spatial filtering and congruent emission and reception beam paths to measure the distance of objects in the nearby surroundings accurately and reliably.

In various examples, a FLASH light source can be combined with a scanner for this purpose. A FLASH light source emits—in addition to the light source which defines the primary emission beam paths via the scanner—further pulsed light which illuminates the surroundings or pulse in a comparatively large angle range—in particular in a larger angle range than the light source per pulse. For this purpose, a strongly divergent emission beam path can be used and/or multiple fanned-out sub-emission beam paths. A corresponding diffusor can be provided. For example, an emission beam path of the FLASH light source can illuminate the surroundings in an angle range of not less than 40°, optionally not less than 100°, furthermore optionally not less than 150°. The spatial region illuminated by the FLASH light source can be formed 1-D or 2-D in this case. For example, a 2-D spatial angle having the dimensions 100°×30° (horizontal×vertical) can be illuminated. Light of the FLASH light source reflected back from objects in the surroundings can then be detected via the reception beam path extending via the scanner. Spatial filtering can thus be achieved.

To achieve an adequate signal-to-noise ratio, the angle range illuminated by the FLASH light source and the scanning range of the scanner are to be aligned with one another. For example, the scanning range could comprise the angle range or the angle range could comprise the scanning range. For example, the angle range could be not less than 40% of the scanning range, optionally not less than 70%, furthermore optionally not less than 100%.

Objects in the near surrounding region can then be measured using the FLASH light source, because the corresponding at least one emission beam path does not extend via the scanner or via the same region of the outer pane and thus back reflections on a deflection unit of the scanner and/or on the outer pane do not cause a particularly large signal at the detector. A saturation of the detector is thus avoided.

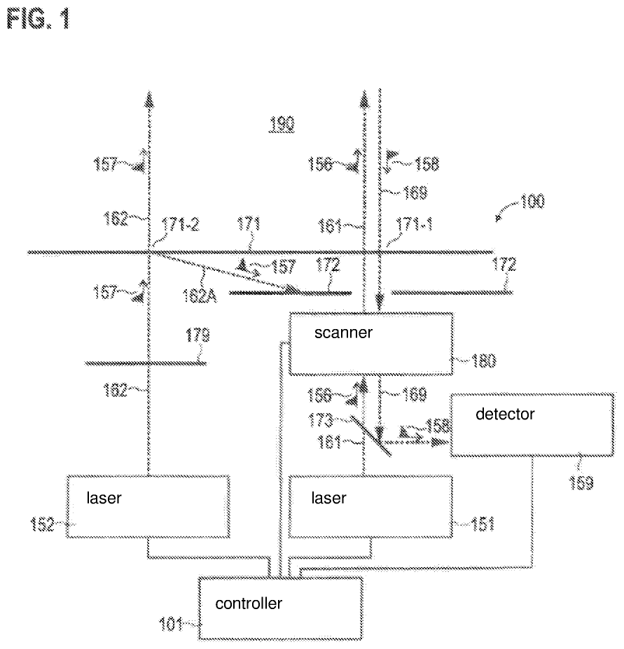

FIG. 1 illustrates aspects with respect to a device 100. The device 100 can carry out LIDAR distance measurements of objects which are arranged in surroundings 190. For this purpose, a controller 101 is provided, which suitably controls lasers 151, 152, a detector 159, and a scanner 180. The controller 101 can carry out a TOF measurement, for example, with respect to laser 151 and detector 159 and also with respect to laser 151 and detector 159. The controller could be designed as an FPGA or ASIC and/or as software, which is executed on a microprocessor.

FIG. 1 illustrates in particular aspects with respect to beam paths 161, 162, 169 which are defined by the device 100. The emission beam path 161 extends from the laser 151 via a scanner 180 to the surroundings 190. In this case, the beam path 161 encounters an outer pane 171 of the device in the region 171-1.

The emission beam path 162 extends from the laser 152 to the surroundings 190, but does not pass the scanner 180 here. In this case, the beam path 162 encounters the outer pane 171 of the device in the region 171-2, which is spaced apart from the region 171-1. The distance between the regions 171-1, 171-2 can be, for example, greater than 1 cm and thus significantly greater than the beam cross sections of the emission beam paths 161, 162 in the region of the outer pane 171. The outer pane can in general be formed in one piece or multiple pieces.

A reception beam path 169 extends from the surroundings 190 via the scanner 180 and then to a detector 159. Reflected light pulses 169 are received along the reception beam path 159 and can be detected by the detector 159. It is apparent from FIG. 1 that the beam paths 161, 169 extend superimposed, i.e., antiparallel in relation to one another and congruently, in the location space between the outer pane 171 and a beam splitter 173. However, the reception beam path 169 does not extend congruently with the emission beam path 162. Moreover, it is apparent that the emission beam paths 161, 162 extend spaced apart from one another.

The lasers 151, 152 can emit laser light having overlapping or identical frequencies. The detector 159 can then be operated particularly simply, because it is not necessary to switch over between different sensitive spectral ranges.

The detector 159 and the lasers 151, 152 are stators in relation to the moving movement system of one or more deflection units of the scanner 180. This enables a particularly small, space-saving, and robust design of the scanner, in particular in comparison to systems in which the lasers 151, 152 and the detector 159 are also, for example, rotated by means of a ball bearing, see, for example, U.S. Pat. No. 7,969,558 B2.

A reflection of the emission beam path 161 causes, in the region 171-1 of the outer pane 171, a strong signal at the detector 159, which is thus saturated for a certain duration—for example, between 50 ns and 150 ns. Moreover, reflections at one or more deflection units of the scanner 180 can also cause a saturation. Therefore, objects which are arranged close behind the outer pane 171 in the surroundings 190 cannot be measured or can only be measured to a restricted extent by means of light pulses 156 which are emitted by the laser 151.

To measure such close objects, light pulses 157 which are emitted by the laser 152 are used instead. Reflections 162A of light pulses 157, which propagate along the emission beam path 162 and which occur in the region 171-2 of the outer pane 171, do not reach the detector 159, because a corresponding screen 172 is provided. This avoids a saturation of the detector 159. The screen can be attached simply due to the spatial separation of the emission beam paths 161, 162.

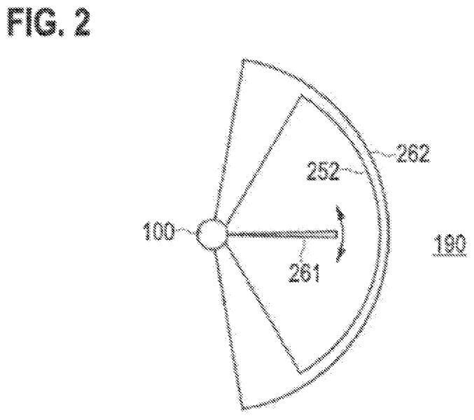

At the same time, however, it is to be ensured that the objects in the surroundings 190 to be measured by means of the reception beam path 169—and thus via the scanner 180—are illuminated by means of the light pulses 157. For this purpose, it can be provided that the emission beam path 162 illuminates a comparatively large angle range in the surroundings 190. This is illustrated in conjunction with FIG. 2.

FIG. 2 illustrates aspects with respect to an angle range 262, which is illuminated in the surroundings 190 by means of the light pulses 157 by the emission beam path 162. It is apparent from FIG. 2 that the angle range 262 is approximately 160°. In general, it would be possible that the angle range 262 is not less than 40°, optionally not less than 100°, furthermore optionally not greater than 150°. The angle range 262 is thus comparatively large, because of which the laser 152 can also be referred to as a FLASH laser 152: this is because the large angle range 262 is illuminated with every laser pulse 157—and not only a small portion of the surroundings 190.

Various technologies are conceivable to implement such comparatively large angle ranges 262. For example, a diffusor 179 (cf. FIG. 1) can be provided in the beam path 162. The diffusor 179 can be configured to increase the divergence of the beam path 162: this means that a light pulse 157 has a smaller position space divergence before the diffusor 179, for example, in the order of magnitude of 1° or 10°. The divergence can be enlarged after the diffusor 179, in accordance with the angle range 262, i.e., for example, by a factor of 5 or 10 or more. The diffusor could be implemented by a scattering pane, for example, made of quartz glass or plastic. However, the diffusor 179 could also be configured to fan out the beam path 162, i.e., to form multiple small sub-beam paths. Each sub-beam path can then have a comparatively small divergence; while the large angle range 262 can nonetheless be illuminated by the fanning out. In some examples, multiple FLASH lasers could also be used, which generate multiple emission beam paths positioned like a fan, in order to illuminate the angle range 262; the diffusor 179 can then be superfluous. For example, a vertical-cavity surface-emitting laser (VCSEL) array could be used.

FIG. 2 also illustrates aspects with respect to an angle range 261, which is illuminated in the surroundings 190 by means of the light pulses 156 by the emission beam path 161. In this case, the angle range 261 is shown by way of example with respect to a single scanning angle of the scanner 180. A scanning range 252 is scanned by the emission beam path 161—and by the reception beam path 169—by the movement of the at least one deflection unit of the scanner 180. Due to the scanning, the emission beam path 161 can have a comparatively small divergence, for example, in the range of 0.05-1.5°; very remote objects can thus also be detected, because the available light is bundled onto the small angle range 161. For example, objects can be recognized in the surroundings 190 which have a distance of 100-200 m. At the same time, however, objects can be detected which are arranged in the larger scanning range 252.

It is apparent from FIG. 2 that the scanning range 252 overlaps with the angle range 262. Therefore, objects in the surroundings 190 which are illuminated by means of the emission beam path 162 by the light pulses 157 can be detected via the reception beam path 169 by means of the reflected light pulses 158. This also means that in each case only a small part of the light emitted by the FLASH laser 152 is measured per scanning angle, namely the part which is acquired by the spatial filtering of the scanner 180. Above all objects in the close surroundings 190 can thus be detected by means of the light emitted by the FLASH laser 152, for example, at a distance of up to 10 m or 20 m. In general, the angle range 262 can be not less than 40% of the scanning range 252, optionally not less than 70%, furthermore optionally not less than 100%, furthermore optionally not less than 120%.

In FIG. 2, the scanning range 252 and the angle range 262, and also the angle range 261, are shown in 1-D; in general, the scanning range 252 and the angle range 262 and the angle range 261 can also be formed 2-D, however, wherein then—in accordance with the above-described features—an overlap can exist in two dimensions and/or the angle range 262 can in turn comprise the scanning range 252 or the scanning range 252 can comprise the angle range 262.

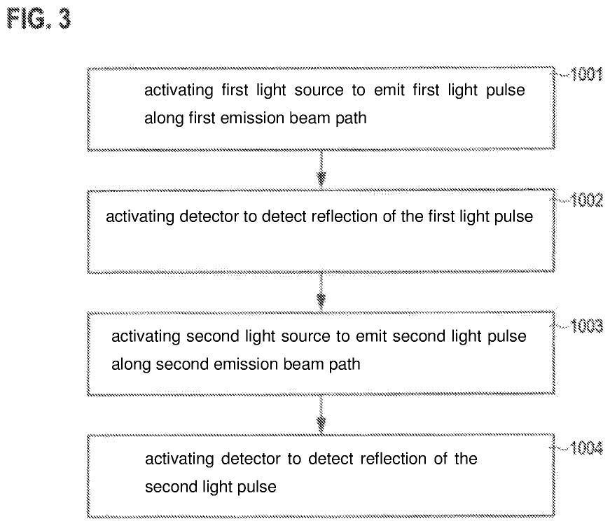

FIG. 3 is a flow chart of an exemplary method. The method begins in block 1001. In block 1001, a first light source—for example, the laser 151—is activated, so that it emits a light pulse—for example, the light pulse 156—along a first emission beam path—for example, the emission beam path 161. These light pulses are emitted via a scanner.

In block 1002, a detector—for example, the detector 159—is then activated, so that it detects a reflection of the light pulse from block 1001 along a reception beam path—for example, the reception beam path 169.

In block 1003, at least one second laser—for example, the FLASH laser 152—is then activated, so that it emits a light pulse—for example, the light pulse 157—along at least one second emission beam path—for example, the emission beam path 162. These light pulses are not emitted via the scanner.

In block 1003, the detector is then activated, so that it detects a reflection of the light pulse from block 1003 along the reception beam path.

It would then be possible to carry out a LIDAR distance measurement, i.e., for example, to measure the light runtimes respectively between blocks 1001 and 1002 and also between blocks 1003 and 1004. In this case, the light runtime between blocks 1001 and 1002 can be suitable for detecting objects comparatively far away, for example, objects which are arranged farther away than 10 m. This can be achieved by a comparatively small divergence of the first emission beam path. At the same time, however, shortly after emission of the light pulse in block 1001, a reflection of this light pulse on an outer pane of the corresponding device can saturate the detector for a duration of, for example, up to 100 ns. This can be the case in particular if the first emission beam path and the reception beam path are arranged overlapping, so that the light reflected on the outer pane and/or on a deflection unit of the scanner can reach the detector unobstructed. Objects which have a distance which corresponds to a light runtime in the order of magnitude of this saturation duration then cannot be measured by reflection of the light pulse from block 1001; instead, reflections of the light pulse from block 1003 can be used in block 1004. This is because the corresponding at least one second emission beam path can be arranged non-overlapping with the reception beam path, so that light reflected on the outer pane cannot reach the detector or can only reach the detector to a very limited extent. Saturation of the detector therefore does not take place in block 1003 due to reflection on the outer pane.

A duration between blocks 1001 and 1003 can be less than 2% of the scanning period of the scanner, optionally less than 1%, furthermore optionally less than 0.1%, furthermore optionally less than 0.01%. This means that the duration between the pulse of the FLASH laser and the pulse of the further laser can correlate with the scanning frequency. For example, the scanning frequency can be in the range of 100 Hz-5 kHz, i.e., the scanning period could be in the range of 100 ms-0.2 ms. The duration between blocks 1001 and 1003 could accordingly not be greater than 2 ms or 4 μs, respectively. Such a duration is sufficiently large to ensure that saturation due to the light emitted in block 1001 is no longer present in block 1003; at the same time, the deflection unit has not yet moved significantly farther, so that the lateral position resolution is high.

It can sometimes be desirable to carry out blocks 1003 and 1004 first and only then blocks 1001 and 1002. If, for example, only objects at a distance of up to 10 m can be measured by means of blocks 1003 and 1004, the duration until 1001 and 1002 are subsequently carried out can be dimensioned short, for example, less than 0.5 μs: no ambiguities between reflections of the light emitted in 1001 and 1003 on the detector are expected because of the short TOF. Moreover, in such a scenario it can be checked by means of 1003 and 1004 whether an object is located in the close surroundings—if this were the case, carrying out 1001 and 1002 can be omitted or the laser can be activated to emit the pulse having lower light power, in order to ensure ocular safety. This means that based on the measurement signal associated with the second light pulse from 1004, the emission power of the first light pulse from 1001 can be adapted.

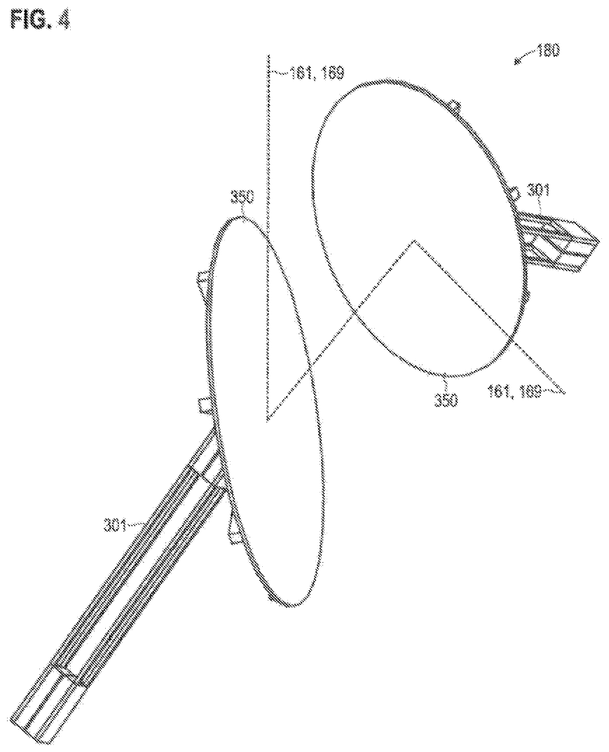

FIG. 4 illustrates aspects with respect to the scanner 180. In the example of FIG. 4, the scanner 180 comprises two mirrors 350, which are encountered sequentially by the emission beam path 161 or by the reception beam path 169, respectively. The light is thus deflected twice, whereby a 2-D scanning range 252 is defined. The mirrors 350 are each held by an elastic suspension 301 having four support elements in each case, which can implement different scanning angles by deformation. For example, a resonant torsion can take place around the central, longitudinally oriented axis of symmetry of the elastic suspension 301 (torsion mode). The elastic suspension 301 extends from a rear side of the mirror 350, for example, in the idle state at an angle of 45° in relation to the mirror surface. The elastic suspensions 301 can be produced from silicon, for example, from monocrystalline silicon in a wafer process (MEMS manufacturing). Fibers could also be used. For example, electrostatic interdigital finger structures or bending piezoactuators could be used as actuators (not shown in FIG. 4). Corresponding technologies with respect to the scanner 180 are described, for example, in the German patent applications 10 2017 002 235.6, 10 2017 002 866.4, and 10 2017 002 870.2, the content of the disclosure of which is incorporated in its entirety herein by cross-reference.

Of course, the features of the above-described embodiments and aspects of the invention can be combined with one another. In particular, the features can be used not only in the described combinations, but rather also in other combinations or as such, without leaving the scope of the invention.

1. A device, which comprises:
a first emission beam path, which extends from a pulsed first light source via a scanner to surroundings of the device,
a reception beam path, which extends from the surroundings via the scanner to a detector, and
at least one second emission beam, which extends from at least one pulsed second light source and not via the scanner to the surroundings,
a controller, which is configured to activate the pulsed first light source to emit a first light pulse along the first emission beam path, and to activate the at least one pulsed second light source, to emit a second light pulse along the at least one second emission beam path, and
wherein the controller is furthermore configured to activate the detector to detect a reflection of the first light pulse along the reception beam path and to detect a reflection of the second light pulse along the reception beam path.

2. The device as claimed recited in claim 1, further including
at least one outer pane, which separates the device from the surroundings,
wherein the first emission beam path and the at least one second emission beam path encounter the at least one outer pane in different regions.

3. The device as claimed recited in claim 1, further including
a screen, which is arranged between at least one outer pane of the device and the detector and is configured to block light of the at least one pulsed second light source reflected on at least one outer pane of the device.

4. The device as recited in claim 1,
wherein the at least one second emission beam path, with respect to a single pulse of the at least one pulsed second light source, illuminates the surroundings in an angle range of not less than 40°.

5. The device as recited in claim 1,
wherein the at least one second emission beam path, with respect to a single pulse of the at least one pulsed second light source, illuminates the surroundings in an angle range which is not less than 40% of a scanning range of the scanner.

6. The device as recited in claim 1, further including
a diffusor, which is arranged in the at least one second emission beam path and is configured to enlarge a divergence of the at least one second emission beam path and/or to fan out the at least one second emission beam path.

7. The device as recited in claim 1,
wherein the reception beam path and the first emission beam path extend at least partially congruently.

8. The device as recited in claim 1, wherein the controller
configured to activate the pulsed first light source to emit the first light pulse along the first emission beam path at a first point in time, and to activate the at least one pulsed second light source to emit the second light pulse along the at least one second emission beam path at a second point in time, and further
wherein an absolute value of a duration between the first point in time and the second point in time is not greater than 2% of a scanning period of the scanner.

9. The device as recited in claim 8,
wherein the controller is configured to receive a measurement signal associated with the second light pulse from the detector and to determine an emission power of the first light pulse based on the measurement signal.

10. A method, which comprises:
activating a pulsed first light source to emit a first light pulse along a first emission beam path via a scanner into surroundings,
activating a detector to detect a reflection of the first light pulse along a reception beam path, which extends from the surroundings via the scanner,
activating at least one pulsed second light source to emit a second light pulse along at least one second emission beam path and not via the scanner into the surroundings, and
activating the detector to detect a reflection of the second light pulse along the reception beam path.

11. The device as recited in claim 2, further including:
a screen, which is arranged between at least one outer pane of the device and the detector and is configured to block light of the at least one pulsed second light source reflected on at least one outer pane of the device.

12. The device as recited in claim 1, wherein the at least one second emission beam path, with respect to a single pulse of the at least one pulsed second light source, illuminates the surroundings in an angle range of not less than 100°.

13. The device as recited in claim 1, wherein the at least one second emission beam path, with respect to a single pulse of the at least one pulsed second light source, illuminates the surroundings in an angle range of not less than 150°.

14. The device as recited in claim 1, wherein the at least one second emission beam path, with respect to a single pulse of the at least one pulsed second light source, illuminates the surroundings in an angle range which is not less than 70% of a scanning range of the scanner.

15. The device as recited in claim 1, wherein the at least one second emission beam path, with respect to a single pulse of the at least one pulsed second light source, illuminates the surroundings in an angle range which is not less than 100% of a scanning range of the scanner.

16. The device as recited in claim 1, wherein the reception beam path and the first emission beam path extend non-congruently.
